(19) United States
(12) Patent Application Publication
(10) Pub. No.: US 2024/0307954 A1
(43) Pub. Date: Sep. 19, 2024

(54) ADDITIVE MANUFACTURING POWDER AND ADDITIVELY MANUFACTURED OBJECT

(71) Applicant: SEIKO EPSON CORPORATION, Tokyo (JP)

(72) Inventors: Keisuke AIDA, Hachinohe-shi (JP); Toshiki SANO, Hachinohe-shi (JP)

(21) Appl. No.: 18/606,644

(22) Filed: Mar. 15, 2024

(30) Foreign Application Priority Data
Mar. 15, 2023 (JP) 2023-040519

(51) Int. Cl. B22F 1/05; B22F 1/065; B22F 10/28; B33Y 70/00; B33Y 80/00

(52) U.S. Cl. CPC B22F 1/05; B22F 1/065; B22F 10/28; B33Y 70/00; B33Y 80/00; B22F 2301/35; B22F 2304/10

(57) ABSTRACT

An additive manufacturing powder includes an Fe-based metal material and is used to manufacture an additively manufactured object that is to be turned into a metal sintered object by sintering. The additive manufacturing powder has a particle size D50 of 1.0 μm or greater and less than 15.0 μm, and a particle size difference D90-D10 between a particle size D90 and a particle size D10 of from 5.0 μm to 18.0 μm, where, in a volume-based cumulative particle size distribution curve, D10 is the particle size at which the cumulative volume of particles reaches 10% as counted from the smaller side, D50 is the particle size at which the cumulative volume of the particles reaches 50% as counted from the smaller side, and D90 is the particle size at which the cumulative volume of the particles reaches 90% as counted from the smaller side. The additive manufacturing powder also has a specific surface area of from 0.05 [m²/g] to 0.25 [m²/g], and a water content of 200 ppm or less as measured by the Karl Fischer method at 250° C. An average circularity of the particles is from 0.85 to 0.99.

The present application is based on, and claims priority from JP Application Serial Number 2023-040519, filed Mar. 15, 2023, the disclosure of which is hereby incorporated by reference herein in its entirety.

### BACKGROUND

### 1. Technical Field

The present disclosure relates to an additive manufacturing powder and an additively manufactured object.

### 2. Related Art

Additive manufacturing using metal powder has been used widely in recent years as a technique for manufacturing three dimensional objects. Depending on the bonding mechanism, various types of additive manufacturing are known, such as fused deposition modeling (FDM), selective laser sintering (SLS), and binder jetting.

JP-A-2016-102229 discloses a metal additive manufacturing powder including a large number of particles, the particles containing at least one type of Ni, Fe, and Co, and the total content of Ni, Fe, and Co being 50 mass % or greater, wherein a ratio P1 of the number of particles having a circularity of less than 0.80 to the total number of particles is 10% or less, and a ratio P3 of the number of particles having a circularity of 0.95 or greater to the total number of particles is 50% or greater.

Such a metal additive manufacturing powder includes a large number of particles having a large degree of circularity, making it possible to manufacture a manufactured object having excellent handleability and high strength.

In addition, sintering the manufactured object can effectively manufacture a metal sintered object.

However, the metal additive manufacturing powder described in JP-A-2016-102229 has a particle size D50, which corresponds to an average particle size, of 15 μm or greater. This number is relatively large. As such, the resulting manufactured object has a low sinterability of the metal powder. In addition, the smaller the particle size, the lower the flowability of the powder tends to be, and the lower the filling property of the powder tends to be. As such, when the particle size is reduced to improve sinterability, it is necessary to suppress a decrease in flowability.

The situation presents the challenge of realizing an additive manufacturing powder having both good sinterability and good flowability.

### SUMMARY

An additive manufacturing powder according to an application example of the present disclosure is an additive manufacturing powder including an Fe-based metal material and used to manufacture an additively manufactured object, the additively manufactured object being to be turned into a metal sintered object by sintering, in which the additive manufacturing powder has a particle size D50 of 1.0 μm or greater and less than 15.0 μm, and a particle size difference D90-D10 between a particle size D90 and a particle size D10 of from 5.0 μm to 18.0 μm, where, in a volume-based cumulative particle size distribution curve measured by laser diffraction, D10 is a particle size at which a cumulative volume of particles reaches 10% as counted from a smaller side, D50 is a particle size at which the cumulative volume of the particles reaches 50% as counted from the smaller side, and D90 is a particle size at which the cumulative volume of the particles reaches 90% as counted from the smaller side, the additive manufacturing powder has a specific surface area of from 0.05 [m²/g] to 0.25 [m²/g], the additive manufacturing powder has a water content of 200 ppm or less as measured by a Karl Fischer method at 250° C., and an average circularity of the particles is from 0.85 to 0.99.

An additively manufactured object according to an application example of the present disclosure includes the additive manufacturing powder according to an application example of the present disclosure, and a binder configured to bond together the particles of the additive manufacturing powder.

### BRIEF DESCRIPTION OF THE DRAWINGS

FIG. 1 is a flowchart explaining a method of manufacturing an additively manufactured object.

FIG. 2 is a diagram explaining the method of manufacturing the additively manufactured object illustrated in FIG. 1.

FIG. 3 is a diagram explaining the method of manufacturing the additively manufactured object illustrated in FIG. 1.

FIG. 4 is a diagram explaining the method of manufacturing the additively manufactured object illustrated in FIG. 1.

FIG. 5 is a diagram explaining the method of manufacturing the additively manufactured object illustrated in FIG. 1.

FIG. 6 is a diagram explaining the method of manufacturing the additively manufactured object illustrated in FIG. 1.

FIG. 7 is a diagram explaining the method of manufacturing the additively manufactured object illustrated in FIG. 1.

FIG. 8 is a diagram explaining the method of manufacturing the additively manufactured object illustrated in FIG. 1.

FIG. 9 is a diagram explaining the method of manufacturing the additively manufactured object illustrated in FIG. 1.

FIG. 10 is a diagram explaining the method of manufacturing the additively manufactured object illustrated in FIG. 1.

### DESCRIPTION OF EMBODIMENTS

Hereinafter, an additive manufacturing powder and an additively manufactured object according to a preferred embodiment of the present disclosure will be described in detail based on the accompanying drawings.

### 1. Method of Manufacturing Additively Manufactured Object

First, a method of manufacturing an additively manufactured object using an additive manufacturing powder will be described.

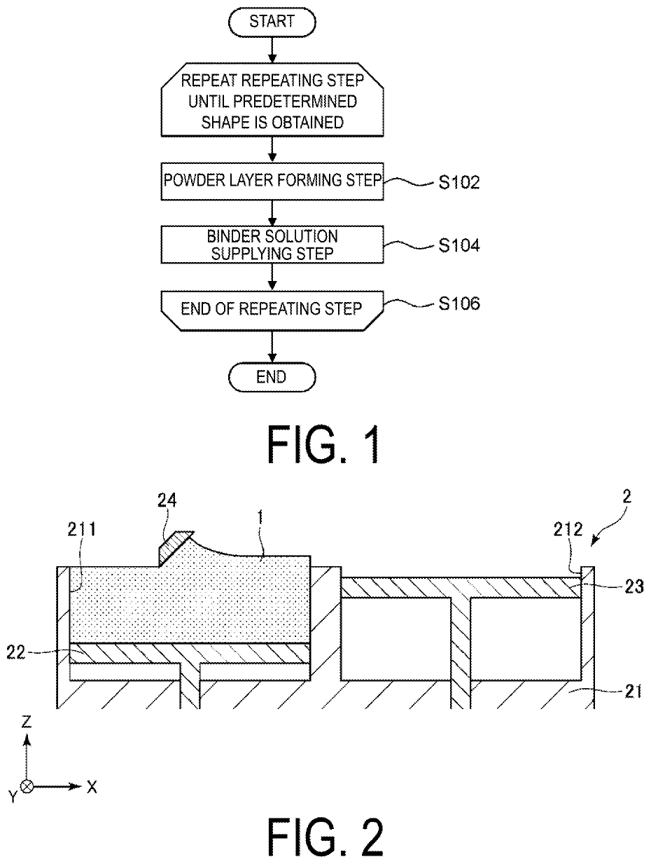

FIG. 1 is a flowchart explaining a method of manufacturing an additively manufactured object. FIG. 2 through FIG. 10 are each a diagram explaining the method of manufacturing the additively manufactured object illustrated in FIG. 1. Note that in FIG. 2 through FIG. 10 of the present application, the X-axis, Y-axis, and Z-axis are set as three mutually orthogonal axes. Each axis is represented by an arrow, with the tip end being the “plus side” and the base end being the “minus side”. In the following description, in particular, the plus side of the Z-axis is referred to as “upper”, and the minus side of the Z-axis is referred to as “lower”. Furthermore, both directions parallel to the X-axis are referred to as the X-axis directions, both directions parallel to the Y-axis are referred to as the Y-axis directions, and both directions parallel to the Z-axis are referred to as the Z-axis directions.

The method of manufacturing an additively manufactured object illustrated in FIG. 1 through FIG. 10 is a type of additive manufacturing called binder jetting. As illustrated in FIG. 1, the method of manufacturing an additively manufactured object includes a powder layer forming step S102, a binder solution supplying step S104, and a repeating step S106. Binder jetting does not require a support structure for supporting the manufactured object, which allows for the production of an additively manufactured object having a complicated shape.

In the powder layer forming step S102, an additive manufacturing powder 1 is laid down to form a powder layer 31. In the binder solution supplying step S104, a binder solution 4 is supplied to a predetermined region of the powder layer 31, bonding the particles in the powder layer 31 together and resulting in a bonding layer 41. In the repeating step S106, the powder layer forming step S102 and the binder solution supplying step S104 are repeated one or more times, resulting in an additively manufactured object 6 as illustrated in FIG. 10. Each step will be described below in sequence.

The additively manufactured object 6 produced becomes a metal sintered object by being subjected to a sintering treatment. The resulting metal sintered object reflects the shape of the additively manufactured object, and thus a metal sintered object having a complicated shape can be efficiently manufactured.

### 1.1. Additive Manufacturing Apparatus

First, an additive manufacturing apparatus 2 will be described prior to the description of the powder layer forming step S102.

The additive manufacturing apparatus 2 includes an apparatus main body 21 including a powder storage unit 211 and a fabrication unit 212, a powder supply elevator 22 provided in the powder storage unit 211, a fabrication platform 23 provided in the fabrication unit 212, and a coater 24, a roller 25, and a liquid supply unit 26 movably provided on the apparatus main body 21.

The powder storage unit 211 is provided in the apparatus main body 21 and is a recessed portion with its upper portion open. The powder storage unit 211 stores the additive manufacturing powder 1. The coater 24 supplies an appropriate amount of the additive manufacturing powder 1 stored in the powder storage unit 211 to the fabrication unit 212.

The powder supply elevator 22 is disposed at the bottom of the powder storage unit 211. The powder supply elevator 22 can move upward and downward with the additive manufacturing powder 1 placed thereon. By moving upward, the powder supply elevator 22 pushes the additive manufacturing powder 1 placed on the powder supply elevator 22 up and causes the additive manufacturing powder 1 to spill out of the powder storage unit 211. As such, the portion of the additive manufacturing powder 1 spilled out can be moved to the side of the fabrication unit 212.

The fabrication unit 212 is provided in the apparatus main body 21 and is a recessed portion with its upper portion open. The fabrication platform 23 is disposed inside the fabrication unit 212. The coater 24 lays the additive manufacturing powder 1 in a layer on the fabrication platform 23. In addition, the fabrication platform 23 can move upward and downward with the additive manufacturing powder 1 laid thereon. By appropriately setting the height of the fabrication platform 23, the amount of the additive manufacturing powder 1 laid on the fabrication platform 23 can be adjusted.

The coater 24 and the roller 25 are movable in the X-axis directions between the powder storage unit 211 and the fabrication unit 212. The coater 24 can level and spread the additive manufacturing powder 1 to lay the additive manufacturing powder 1 in a layer. The roller 25 compresses the leveled additive manufacturing powder 1 from above.

The liquid supply unit 26 includes, for example, an ink jet head, a dispenser, or the like, and is movable in the X-axis directions and the Y-axis directions in the fabrication unit 212. The liquid supply unit 26 can also supply a target amount of the binder solution 4 to a target position. Note that the liquid supply unit 26 may be provided with a plurality of discharge nozzles in one head. The plurality of discharge nozzles may discharge the binder solution 4 simultaneously or at an interval.

### 1.2. Powder Layer Forming Step

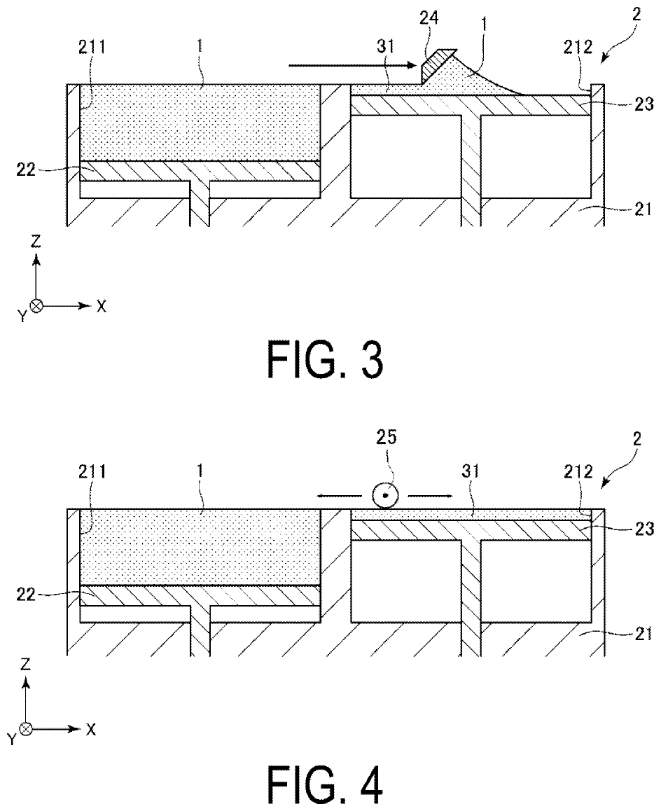

Next, the powder layer forming step S102 using the above-described additive manufacturing apparatus 2 will be described. In the powder layer forming step S102, the additive manufacturing powder 1 is laid on the fabrication platform 23, forming the powder layer 31. Specifically, as illustrated in FIG. 2 and FIG. 3, the coater 24 is used to spread the additive manufacturing powder 1 stored in the powder storage unit 211 onto the fabrication platform 23 and level the additive manufacturing powder 1 to a uniform thickness. This results in the powder layer 31 illustrated in FIG. 4. At this time, the thickness of the powder layer 31 can be adjusted by lowering the upper surface of the fabrication platform 23 to below the upper end of the fabrication unit 212 and adjusting how much to lower. Note that as will be described later, the additive manufacturing powder 1 is a powder having excellent filling property when leveled. Therefore, the powder layer 31 having a high filling rate can be obtained.

Next, as illustrated in FIG. 4, the roller 25 moves in the X-axis directions while compressing the powder layer 31 in a thickness direction. This can increase the filling rate of the additive manufacturing powder 1 in the powder layer 31. Note that the compression by the roller 25 may be performed as necessary, or may be omitted. Further, the powder layer 31 may be compressed by a unit other than the roller 25, such as a pressing plate, for example.

### 1.3. Binder Solution Supplying Step

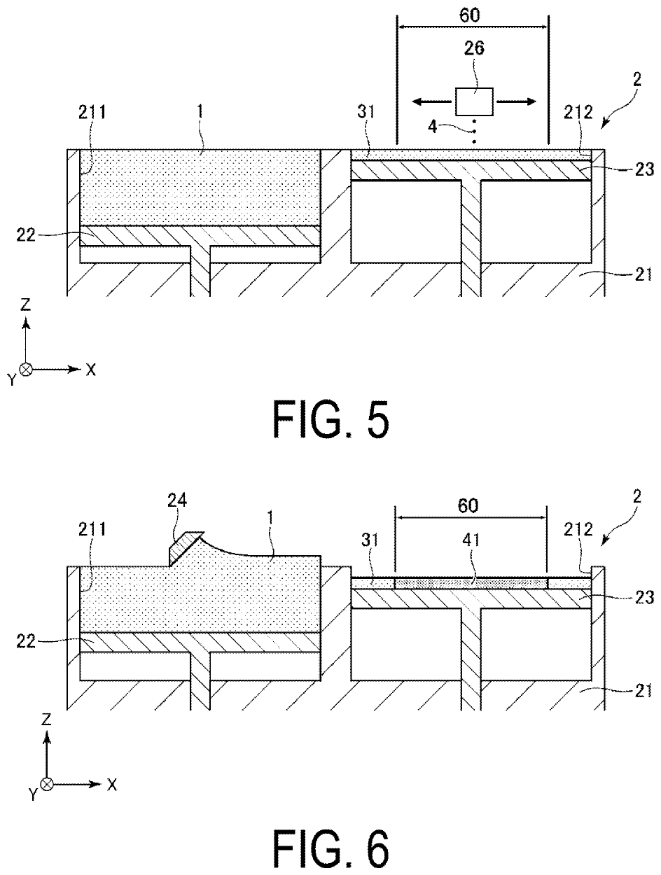

In the binder solution supplying step S104, as illustrated in FIG. 5, the liquid supplying unit 26 supplies the binder solution 4 to a formation region 60 that is in the powder layer 31 and that corresponds to the additively manufactured object 6 to be manufactured. The binder solution 4 is a liquid containing a binder and a solvent or a dispersion medium. In the formation region 60 to which the binder solution 4 is supplied, the particles of the additive manufacturing powder 1 are bonded together, resulting in the bonding layer 41 illustrated in FIG. 6. In the bonding layer 41, the particles of the additive manufacturing powder 1 are bonded together by the binder, and the bonding layer 41 has a shape retention property to a degree that the shape is not broken under the particles' own weight.

Note that the bonding layer 41 may be heated while the binder solution 4 is being supplied or after the binder solution 4 is supplied. This promotes the volatilization of the solvent or the dispersion medium contained in the binder solution 4 and promotes the bonding of the particles by the solidification or curing of the binder. Note that when the binder contains a photocurable resin or an UV curable resin, light irradiation or ultraviolet irradiation may be performed instead of heating or together with heating.

The heating temperature in the case of heating is not limited, but may be from 50° C. to 250° C., and may be from 70° C. to 200° C. Accordingly, a sufficient amount of heat can be applied to the bonding layer 41, sufficiently promoting the volatilization of the solvent or the dispersion medium.

The binder solution 4 is not limited as long as it is a liquid containing a component that can bond particles of the additive manufacturing powder 1 together. Examples of the solvent or the dispersion medium contained in the binder solution 4 include water, alcohols, ketones, carboxylic acid esters, and the like, and may be a mixed liquid containing at least one of the foregoing. E Examples of the binder contained in the binder solution 4 include fatty acids, paraffin wax, microwax, polyethylene, polypropylene, polystyrene, acrylic resins, polyamide resins, polyesters, stearic acid, polyvinylpyrrolidone (PVP), polyvinyl alcohol (PVA), polyethylene glycol (PEG), urethane resins, epoxy resins, vinyl resins, unsaturated polyester resins, and phenol resins.

### 1.4. Repeating Step

In the repeating step S106, the powder layer forming step S102 and the binder solution supplying step S104 are repeated one or more times until a layered object formed by layering a plurality of the bonding layers 41 assumes a predetermined shape. That is, these steps are performed twice or more in total. This results in the three-dimensional additively manufactured object 6 illustrated in FIG. 10.

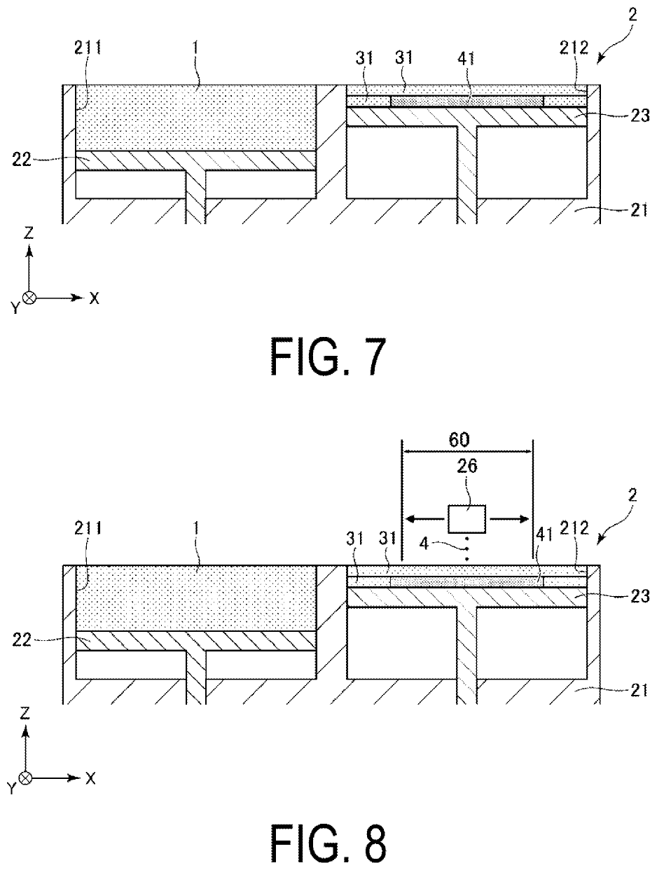

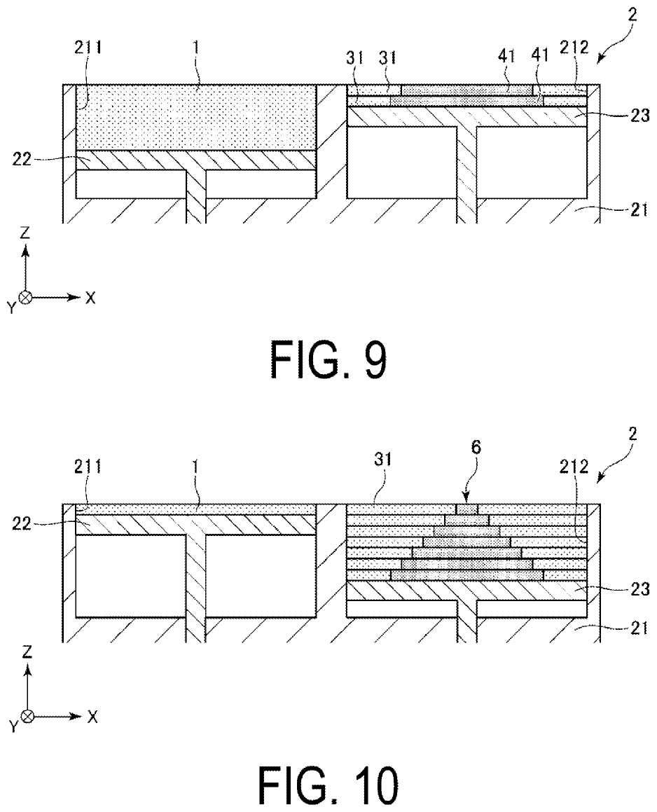

Specifically, first, as illustrated in FIG. 7, a new powder layer 31 is formed on the bonding layer 41 illustrated in FIG. 6. Next, as illustrated in FIG. 8, the binder solution 4 is supplied to a formation region 60 in the newly formed powder layer 31. This results in a second bonding layer 41 illustrated in FIG. 9. The repetition of these operations result in the additively manufactured object 6 illustrated in FIG. 10.

Note that in the powder layer 31, the additive manufacturing powder 1 that does not constitute the bonding layer 41 is collected and reused as necessary, that is, again used toward the manufacturing of the additively manufactured object 6.

The additively manufactured object 6 obtained as described above is subjected to a sintering treatment to be described later.

### 1.5. Method of Manufacturing Metal Sintered Object

Subjecting the additively manufactured object 6 to a sintering treatment results in a metal sintered object. In the sintering treatment, the additively manufactured object 6 is heated to cause a sintering reaction.

The sintering temperature varies depending on the constituent material, the particle size, and the like of the additive manufacturing powder 1. As an example, the sintering temperature may be from 980° C. to 1330° C., and may be from 1050° C. to 1260° C. The sintering time may be from 0.2 hours to 7 hours, and may be from 1 hour to 6 hours.

Examples of the atmosphere of the sintering treatment include a reducing atmosphere such as hydrogen, an inert atmosphere such as nitrogen or argon, and a reduced pressure atmosphere created by reducing the pressure of these atmospheres. The pressure of the reduced pressure atmosphere is not limited as long as it is less than normal pressure (100 kPa), but may be 10 kPa or less, and may be 1 kPa or less.

Note that when the sintering treatment performed under the above-described conditions is referred to as “main sintering”, “preliminary sintering” which corresponds to a pretreatment of the main sintering or “degreasing” may be performed on the additively manufactured object 6 as necessary. This can remove at least a part of the binder contained in the additively manufactured object 6 or cause a sintering reaction in a part of the binder. As such, when the main sintering is performed, unintended deformation or the like can be suppressed.

The temperature of the preliminary sintering or degreasing is not limited as long as it is a temperature at which sintering of the metal powder is not completed. The temperature of preliminary sintering or degreasing may be from 100° C. to 500° C., and may be from 150° C. to 300° C. Further, the duration of the preliminary sintering or degreasing may be 5 minutes or greater, may be from 10 minutes to 120 minutes, and may be from 20 minutes to 60 minutes within the above temperature range. Examples of the atmosphere of the preliminary sintering or degreasing include an air atmosphere, an inert atmosphere such as nitrogen or argon, and a reduced pressure atmosphere created by reducing the pressure of these atmospheres.

The metal sintered object obtained as described above can be used as a material constituting the whole or a part of, for example, transportation equipment parts such as automobile parts, bicycle parts, railway vehicle parts, ship parts, aircraft parts, and space transportation equipment parts; electronic device parts such as personal computer parts, mobile phone parts, tablet parts, and wearable device parts; electrical device parts such as those of refrigerators, washing machines, and air conditioners; machine parts such as those of machine tools and semiconductor manufacturing devices; parts for plants such as nuclear power plants, thermal power plants, hydroelectric power plants, oil refineries, and chemical complexes; and decorative items such as timepiece parts, metal tableware, jewelry, and eyeglass frames.

### 2. Additive Manufacturing Powder

Next, the additive manufacturing powder according to an embodiment will be described.

The additive manufacturing powder 1 according to the present embodiment is a powder used in various types of additive manufacturing such as the above-described binder jetting.

### 2.1. Constituent Material

The additive manufacturing powder 1 contains an Fe-based metal material. The Fe-based metal material refers to a metal material in which the content of Fe is greater than 50% in terms of atomic ratio.

Examples of the Fe-based metal material include stainless steel such as ferritic stainless steel, austenitic stainless steel, martensitic stainless steel, precipitation hardening stainless steel, and austenite-ferritic (duplex) stainless steel; low-carbon steel; carbon steel; heat-resistant steel; die steel; high-speed tool steel; Fe—Ni alloy; and Fe—Ni—Co alloy.

Among these, stainless steel may be used as the Fe-based metal material. Stainless steel is a type of steel having excellent mechanical strength and corrosion resistance. As such, using the additive manufacturing powder 1 composed of stainless steel allows for the efficiently manufacturing of a metal sintered object having excellent mechanical strength, excellent corrosion resistance, and high shape accuracy.

Examples of austenitic stainless steel include SUS301, SUS301L, SUS301J1, SUS302B, SUS303, SUS304, SUS304Cu, SUS304L, SUS304N1, SUS304N2, SUS304LN, SUS304J1, SUS304J2, SUS305, SUS309S, SUS310S, SUS312L, SUS315J1, SUS315J2, SUS316, SUS316L, SUS316N, SUS316LN, SUS316Ti, SUS316J1, SUS316J1L, SUS317, SUS317L, SUS317LN, SUS317J1, SUS317J2, SUS836L, SUS890L, SUS321, SUS347, SUSXM7, and SUSXM15J1.

Examples of ferrite stainless steel include SUS405, SUS410L, SUS429, SUS430, SUS430LX, SUS430J1L, SUS434, SUS436L, SUS436J1L, SUS445J1, SUS445J2, SUS444, SUS447J1, and SUSXM27.

Examples of martensitic stainless steel include SUS403, SUS410, SUS410S, SUS420J1, SUS420J2, and SUS440A.

Examples of precipitation hardening stainless steel include SUS630 and SUS631.

Examples of austenite-ferrite (duplex) stainless steel include SUS329J1, SUS329J3L, and SUS329J4L.

Note that the above designations are material designations based on the JIS standards. The types of stainless steel in the present specification are distinguished based on the above material designations.

The additively manufactured object 6 may be manufactured using the additive manufacturing powder 1 containing different types of stainless steel. Alternatively, the additively manufactured object 6 may include two different parts, with one part being produced using the additive manufacturing powder 1 containing a first stainless steel, and the other part being produced using the additive manufacturing powder 1 containing a second stainless steel.

The additive manufacturing powder 1 may also be provided with a coating film that coats the surface of the core particles composed of the Fe-based metal material. The coating film is provided for the purpose of, for example, increasing the flowability and filling property of the additive manufacturing powder 1 or increasing the affinity between the additive manufacturing powder 1 and the binder. Examples of the constituent material of the coating film include organic materials such as resin, inorganic materials such as ceramics and glass, and compounds derived from a coupling agent.

### 2.2. Various Characteristics of Additive Manufacturing Powder

Next, various characteristics of the additive manufacturing powder 1 will be described. Note that all of the following characteristics are measured when the additive manufacturing powder 1 is not provided with the coating film described above.

### 2.2.1. Particle Size Distribution

When a volume-based particle size distribution is obtained for the additive manufacturing powder 1 according to the present embodiment using a laser diffraction particle size distribution measuring device, the particle size at which the cumulative frequency of particle size reaches 10% from the smaller side is defined as D10. Similarly, the particle sizes when the cumulative frequency of particle size reaches 50%, 90%, and 99% from the smaller side are defined as D50, D90, and D99, respectively. Examples of the particle size distribution measuring device include Microtrac HRA9320-X100 available from Nikkiso Co., Ltd.

The particle size D50 of the additive manufacturing powder 1 is 1.0 μm or greater and less than 15.0 μm, may be from 3.0 μm to 12.0 μm, and may be from 4.0 μm to 10.0 μm. This makes it possible to achieve both the sinterability and the flowability of the additive manufacturing powder 1. This results in the additively manufactured object 6 that is dense and having high manufacturing accuracy, which can in turn be used to eventually manufacture a metal sintered object having high density and high surface accuracy.

Note that when the particle size D50 is less than the lower limit, the particles of the additive manufacturing powder 1 are likely to aggregate. As such, the flowability of the additive manufacturing powder 1 decreases, and the density of the metal sintered object decreases. Meanwhile, when the particle size D50 exceeds the upper limit, the sinterability of the additive manufacturing powder 1 decreases, and the density of the metal sintered object decreases.

The ratio of the particle size D10 to the particle size D50, or D10/D50, may be from 0.30 to 0.70, may be from 0.35 to 0.60, and may be from 0.42 to 0.55. This allows the additive manufacturing powder 1 to have a relatively uniform particle size, making it easy to increase the flowability while ensuring the sinterability. Note that when the ratio D10/D50 is less than the lower limit, the particle size distribution broadens, leading to a possible decrease in the flowability. Meanwhile, when the ratio D10/D50 exceeds the upper limit, the particle size distribution is too narrow instead, making it difficult to increase the filling rate and leading to a possible decrease in the sinterability.

The ratio of the particle size D90 to the particle size D50, or D90/D50, may be from 1.50 to 2.70, may be from 1.70 to 2.60, and may be from 1.90 to 2.50. This allows the additive manufacturing powder 1 to have a relatively uniform particle size, making it easy to increase the flowability while ensuring the sinterability. Note that when the ratio D90/D50 is less than the lower limit, the particle size distribution narrows, making it difficult to increase the filling rate and leading to a possible decrease in the sinterability. Meanwhile, when the ratio D90/D50 exceeds the upper limit, the particle size distribution broadens, leading to a possible decrease in the flowability.

The particle size difference D90-D10 between the particle size D90 and the particle size D10 is from 5.0 μm to 18.0 μm, may be from 8.0 μm to 15.0 μm, and may be from 9.0 μm to 13.0 μm. This allows the particle size distribution of the additive manufacturing powder 1 to become sufficiently narrow, resulting in high flowability. As a result, the filling property of the additive manufacturing powder 1 increases, making it possible to obtain the additively manufactured object 6 that is dense and having high manufacturing accuracy.

Note that when the particle size difference D90-D10 is less than the lower limit, the particle size distribution of the additive manufacturing powder 1 becomes extremely narrow, making it difficult to increase the filling rate and leading to a decrease in the sinterability. This causes a decrease in the density and surface accuracy of the resulting metal sintered object. Meanwhile, when the particle size difference D90-D10 exceeds the upper limit, the particle size distribution of the additive manufacturing powder 1 broadens, and the flowability decreases. This causes a decrease in the density and surface accuracy of the resulting sintered object.

### 2.2.2. Specific Surface Area

The specific surface area of the additive manufacturing powder 1 is from 0.05 [m²/g] to 0.25 [m²/g], may be from 0.10 [m²/g] to 0.22 [m²/g], and may be from 0.15 [m²/g] to 0.20 [m²/g]. When the specific surface area is within the above range, both the sinterability and the flowability of the additive manufacturing powder 1 can be achieved. This results in the additively manufactured object 6 that is dense and having high manufacturing accuracy, which can in turn be used to eventually manufacture a metal sintered object having high density and high surface accuracy.

Note that when the specific surface area is less than the lower limit, the sinterability of the additive manufacturing powder 1 decreases, and the density of the metal sintered object decreases. Meanwhile, when the specific surface area exceeds the upper limit, the sinterability of the additive manufacturing powder 1 increases, but in contrast, the flowability of the additive manufacturing powder 1 decreases, and the density and the surface accuracy of the metal sintered object decrease.

The specific surface area of the additive manufacturing powder 1 is obtained by the BET method. Examples of the specific surface area measuring device include a BET specific surface area measuring device HM1201-010 available from Mountech Co., Ltd., and the amount of the sample is 5 g.

### 2.2.3. Average Circularity

The average circularity of the additive manufacturing powder 1 may be from 0.85 to 0.99, may be from 0.86 to 0.98, and may be from 0.87 to 0.97. This allows the particles to roll easily even when the additive manufacturing powder 1 has a small particle size, and puts the filling state closer to close-packing. As a result, both the sinterability and the flowability of the additive manufacturing powder 1 can be achieved. This results in the additively manufactured object 6 that is dense and having high manufacturing accuracy, which can in turn be used to eventually manufacture a metal sintered object having high density and high surface accuracy.

Note that when the average circularity is less than the lower limit, the average circularity decreases, and thus both the flowability and the filling rate of the additive manufacturing powder 1 decrease. Meanwhile, when the average circularity exceeds the upper limit, the manufacturing difficulty increases, leading to a decrease in the manufacturing efficiency of the additive manufacturing powder 1.

The average circularity of the additive manufacturing powder 1 is measured as follows.

First, an image (secondary electron image) of the additive manufacturing powder 1 is captured using a scanning electron microscope (SEM). Next, the captured image is loaded into image processing software. Examples of the image processing software that can be used include image analysis type particle size distribution measurement software “Mac-View” available from Mountech Co., Ltd. Note that the imaging magnification is adjusted to 50 to 100 particles per image. Then, a plurality of the images are acquired to give images of a total of 300 or more particles.

Next, using software, the circularities of images of a total of 300 or more particles are calculated to arrive at an average value. The resulting average value is the average circularity of the additive manufacturing powder 1. Note that the circularity, which is denoted by e, is calculated using the following equation, where S represents the area of the image of a particle and L represents the perimeter of the image of a particle.

e=4πS/L²

### 2.2.4. Water Content

The water content of the additive manufacturing powder 1 is 200 ppm or less, may be from 30 ppm to 200 ppm, may be from 40 ppm to 150 ppm, and may be from 50 ppm to 100 ppm. When the water content is within the above range, a decrease in flowability due to adsorption of water can be suppressed. This results in the additive manufacturing powder 1 having excellent flowability. In addition, when the water content is within the above range, how easy the additive manufacturing powder 1 is charged can be controlled within an appropriate range, and a decrease in flowability caused by charging can be suppressed.

Note that the water content may be less than the lower limit, but this will make it easy for the additive manufacturing powder 1 to be charged, leading to a possible decrease in flowability. Meanwhile, when the water content exceeds the upper limit, the water content of the additive manufacturing powder 1 becomes too high, resulting in a decrease in flowability.

The water content of the additive manufacturing powder 1 is measured by leaving the additive manufacturing powder 1 to be measured in an environment at a temperature of 25° C. and a relative humidity of 50% for 1 hour or greater and then measuring the additive manufacturing powder 1 at 250° C. by the Karl Fischer method. The measurement can use, for example, a water content measuring device CA-310 available from Nittoseiko Analytech Co., Ltd.

### 2.2.5. Oxygen Content

The oxygen content of the additive manufacturing powder 1 may be from 1000 ppm to 4000 ppm, may be from 1500 ppm to 3500 ppm, and may be from 2000 ppm to 3000 ppm in terms of mass ratio. When the oxygen content is within the above range, changes in characteristics over time can be suppressed while adsorption of water content is being suppressed. That is, the resulting additive manufacturing powder 1 has high storage stability.

Note that when the oxygen content is less than the lower limit, the oxide film present on the surface of the particles of the additive manufacturing powder 1 becomes thin, leading to possible changes over time. Meanwhile, when the oxygen content exceeds the upper limit, water content is likely to be adsorbed and the amount of water content increases, leading to a possible decrease in the flowability of the additive manufacturing powder 1.

The oxygen content of the additive manufacturing powder 1 is measured, for example, in accordance with the general rules for determination of oxygen in metallic materials specified in JIS Z 2613:2006. Specifically, the oxygen content of the additive manufacturing powder 1 can be measured, for example, by an oxygen/nitrogen elemental analyzer TC-300/EF-300 available from LECO Corporation, or an oxygen/nitrogen/hydrogen elemental analyzer ONH836 available from LECO Corporation.

### 2.2.6. Bulk Density and Tapped Density

The bulk density of the additive manufacturing powder 1 may be from 2.50 g/cm³ to 3.50 g/cm³, may be from 2.70 g/cm³ to 3.40 g/cm³, and may be from 3.00 g/cm³ to 3.30 g/cm³. When the bulk density is within the above range, a good filling property can be ensured even in a natural state. As such, when the powder layer 31 is formed using the additive manufacturing powder 1, the powder layer 31 formed can have a high filling rate. This results in the additively manufactured object 6 that is dense and having high manufacturing accuracy, which can in turn be used to eventually manufacture a metal sintered object having high density and high surface accuracy.

The bulk density of the additive manufacturing powder 1 is measured in accordance with the method for the determination of the apparent density of metallic powders specified in JIS Z 2504:2012. In addition, the bulk density may be measured using a powder characteristics evaluation device Powder Tester (trade name) PT-X available from Hosokawa Micron Group. Note that before the measurement of the bulk density, the additive manufacturing powder 1 to be measured may be left in an environment of a temperature of 25° C. and a relative humidity of 50% for 1 hour or greater.

The tapped density of the additive manufacturing powder 1 may be from 4.20 g/cm³ to 4.90 g/cm³, may be from 4.40 g/cm³ to 4.80 g/cm³, and may be from 4.50 g/cm³ to 4.70 g/cm³. When the tapped density is within the above range, a high filling rate can be achieved when the powder layer 31 is being leveled at the fabrication platform 23 or compressed by the roller 25. This results in the additively manufactured object 6 that is dense and having high manufacturing accuracy, which can in turn be used to eventually manufacture a metal sintered object having high density and high surface accuracy.

The tapped density of the additive manufacturing powder 1 is measured by a powder characteristics evaluation device Powder Tester (trade name) PT-X available from Hosokawa Micron Group. Note that before the measurement of the tapped density, the additive manufacturing powder 1 to be measured may be left in an environment of a temperature of 25° C. and a relative humidity of 50% for 1 hour or greater.

Note that the ratio of the tapped density to the bulk density of the additive manufacturing powder 1 may be from 1.2 to 1.8, may be from 1.3 to 1.7, and may be from 1.4 to 1.6. When the ratio is within the above range, the difference in filling rate between the additive manufacturing powder 1 in the natural state and the additive manufacturing powder 1 after the application of vibration, a load, or the like can be reduced. This makes it possible to suppress deformation or the like of the additively manufactured object 6 attributable to a difference in filling rate. This results in a metal sintered object having high surface accuracy.

Note that the ratio may be less than the lower limit, but this will lead to a possible increase in the difficulty of stably manufacturing the additive manufacturing powder 1 having described characteristics. Meanwhile, when the ratio exceeds the upper limit, the difference in filling rate increases, leading to a possible deformation or the like of the additively manufactured object 6.

### 3. Method of Manufacturing Additive Manufacturing Powder

Next, an example of a method of manufacturing the additive manufacturing powder will be described.

The additive manufacturing powder may be manufactured by any manufacturing method, such as atomization. During atomization, molten metal flows down from a crucible and collides with a fluid body such as a liquid or gas jetted at high speed. The molten metal collided with the fluid body falls due to inertia, during which the droplets become spherical. This allows for the manufacturing of a metal powder having a high average circularity and a relatively small specific surface area in spite of its relatively small size. Further, reducing the specific surface area can reduce the water content.

Examples of atomization include water atomization, gas atomization, and rotating water atomization, which have different cooling media and device configurations.

The amount of molten metal flowing down varies depending on the device size and the like, but may be greater than 1.0 [kg/min] and 20.0 [kg/min] or less, and may be from 2.0 [kg/min] to 10.0 [kg/min]. As a result, the amount of molten metal flowing down in a given time can be optimized, making it possible to manufacture a metal powder having a narrow particle size distribution and in which each particle becomes sufficiently spherical. This allows for the manufacturing of a metal powder having a high average circularity and a relatively small specific surface area in spite of its relatively small size. Further, reducing the specific surface area can reduce the water content.

The temperature of the molten metal in the crucible (casting temperature) may be set to from Tm+100° C. to Tm+350° C., may be set to from Tm+180° C. to Tm+320° C., and may be set to from Tm+250° C. to Tm+300° C. relative to Tm [° C.], which is the melting point of the constituent material of the additive manufacturing powder. With this configuration, when being atomized by various types of atomization and before becoming solidified, the molten metal can exist as molten metal for a duration longer than known cases. This allows for the manufacturing of a metal powder having a high average circularity and a relatively small specific surface area in spite of its small size.

In addition, in various types of atomization, the outer diameter of the trickle when the molten metal flows down is not limited, but may be 3.0 mm or less, may be from 0.3 mm to 2.0 mm, and may be from 0.5 mm to 1.5 mm. This makes it easier for the fluid to uniformly collide with the molten metal, making it easier to uniformly scatter droplets having an appropriate size. This allows for the manufacturing of a metal powder having the above-described average particle diameter, good average circularity, and a narrow particle size distribution.

The metal powder manufactured may be classified as necessary. Examples of the classification method include dry classification, such as sieve classification, inertial classification, and centrifugal classification, as well as wet classification such as sedimentation classification.

### 4. Effects Achieved by Embodiment Described Above

As described above, the additive manufacturing powder 1 according to the embodiment above is an additive manufacturing powder that includes the Fe-based metal material and that is used to manufacture the additive manufactured object 6, the additive manufactured object 6 being to be turned into the metal sintered object by sintering. The additive manufacturing powder 1 according to the embodiment above has the particle size D50, the particle size difference D90-D10, the specific surface area, the water content, and the average circularity of particles each satisfying the following ranges. The particle size D50 is 1.0 μm or greater and less than 15.0 μm, and the particle size difference D90-D10 between the particle size D90 and the particle size D10 is from 5.0 μm to 18.0 μm, where, in a volume-based cumulative particle size distribution curve measured by laser diffraction, D10 is the particle size at which the cumulative volume of the particles reaches 10% as counted from the smaller side, D50 is the particle size at which the cumulative volume of the particles reaches 50% as counted from the smaller side, and D90 is the particle size at which the cumulative volume of the particles reaches 90% as counted from the smaller side. In addition, the specific surface area is from 0.05 [m²/g] to 0.25 [m²/g], the water content is 200 ppm or less as measured by the Karl Fischer method at 250° C., and the average circularity of the particles is from 0.85 to 0.99.

Such a configuration yields the additive manufacturing powder 1 in which both the sinterability and the flowability are achieved. Using the additive manufacturing powder 1 yields the additively manufactured object 6 that is dense and having high manufacturing accuracy, which can in turn be used to eventually manufacture a metal sintered object having high density and high surface accuracy.

In addition, the additive manufacturing powder 1 according to the embodiment above may have an oxygen content of from 1000 ppm to 4000 ppm.

With such a configuration, changes in characteristics over time can be suppressed while adsorption of water content is being suppressed. That is, the resulting additive manufacturing powder 1 has high storage stability.

The additive manufacturing powder 1 according to the embodiment above may have a particle size D50 of from 4.0 μm to 10.0 μm.

Such a configuration yields the additive manufacturing powder 1 with better balanced sinterability and the flowability.

In addition, the additive manufacturing powder 1 according to the embodiment above may have a specific surface area of from 0.10 [m²/g] to 0.22 [m²/g].

Such a configuration yields the additive manufacturing powder 1 with better balanced sinterability and the flowability.

The additive manufacturing powder 1 according to the embodiment above may have a water content of from 30 ppm to 150 ppm.

Such a configuration yields the additive manufacturing powder 1 in which a decrease in flowability due to adsorption of water content is suppressed.

In addition, in the additive manufacturing powder 1 according to the embodiment above, the Fe-based metal material may be stainless steel.

Stainless steel is a type of steel having excellent mechanical strength and corrosion resistance. As such, using the additive manufacturing powder 1 composed of stainless steel allows for the efficiently manufacturing of a metal sintered object having excellent mechanical strength, excellent corrosion resistance, and high shape accuracy.

In addition, in the additive manufacturing powder 1 according to the embodiment above, the ratio of the tapped density to the bulk density may be from 1.2 to 1.8.

With such a configuration, the difference in filling rate between the additive manufacturing powder 1 in the natural state and the additive manufacturing powder 1 after the application of vibration, a load, or the like can be reduced. This makes it possible to suppress deformation or the like of the additively manufactured object 6 attributable to a difference in filling rate. This results in a metal sintered object having high surface accuracy.

In addition, the additively manufactured object 6 according to the embodiment above includes the additive manufacturing powder 1 and the binder that bonds together the particles of the additive manufacturing powder 1.

Benefiting from the high flowability and filling property of the additive manufacturing powder 1, such additively manufactured object 6 is dense and has high manufacturing accuracy. Therefore, for example, sintering the additively manufactured object 6 yields a metal sintered object having high density and high surface accuracy.

Although the additive manufacturing powder and the additively manufactured object according to the present disclosure have been described based on the illustrated embodiment, the disclosure is not limited thereto. For example, the additive manufacturing powder and the additively manufactured object according to the present disclosure may be obtained by adding any component to the embodiment above.

### EXAMPLE

Next, specific examples of the present disclosure will be described.

### 5. Manufacturing of Additive Manufacturing Powder

Additive manufacturing powders of Sample Nos. 1 to 18 were produced by water atomization. The configuration of the additive manufacturing powder of each sample number is as shown in Table 1 to Table 4.

TABLE 1

| | Steel type | Classification |
|---|---|---|
| Steel type 1 | SUS630 (17-4PH) | Precipitation Hardening Stainless Steel |
| Steel type 2 | SUS316L | Austenitic Stainless Steel |
| Steel type 3 | SUS420J2 | Martensitic Stainless Steel |

### 6. Acquisition of Characteristics of Additive Manufacturing Powder

For each additive manufacturing powder, the representative particle size, the specific surface area, the average circularity, the oxygen content, and the water content were measured. The measurement results are shown in Table 2 to Table 4. Note that among the sample numbers of the additive manufacturing powders in Table 2 to Table 4, those that correspond to the present disclosure were classified as “Examples”, and those that did not correspond to the present disclosure were classified as “Comparative Examples”.

### 7. Evaluation of Additive Manufacturing Powder

### 7.1. Bulk Density and Tapped Density

The bulk density and tapped density of the additive manufacturing powders of Sample Nos. 1 to 10 were measured. Then, the ratios of the tapped density to the bulk density were calculated. The measurement results and calculation results are shown in Table 2.

### 7.2. Relative Density of Metal Sintered Object

The additive manufacturing powder of each sample number was used to produce an additively manufactured object having a rectangular parallelepiped shape by binder jetting. The additively manufactured object produced had a size of a length of 40 mm, a width of 20 mm, and a thickness of 5 mm. A stearic acid emulsion was used as the binder solution.

Subsequently, the additively manufactured object produced was subjected to a degreasing treatment, and then sintered in a kiln. The sintering conditions for steel type 1 were 1100° C. and 3 hours in an argon atmosphere. This resulted in a metal sintered object. The sintering conditions were also selected for steel type 2 and steel type 3 in accordance with the composition.

Next, the density of the resulting metal sintered object was measured. Next, the relative density, which is the relative value of the measured density to the true density of the additive manufacturing powder used, was calculated. The calculated relative density was evaluated according to the following evaluation criteria. The evaluation results are shown in Table 2 to Table 4.
A: The relative density is 99.0% or greater.
B: The relative density is 98.5% or greater and less than 99.0% .
C: The relative density is 98.0% or greater and less than 98.5% .
D: The relative density is less than 98.0% .

### 7.3. Surface Roughness of Metal Sintered Object

The surface roughness of the largest surface of the resulting metal sintered object was measured. This surface roughness refers to the arithmetic mean roughness Ra, and was measured in accordance with the method specified in JIS B 0671-1:2002. Relative evaluation was carried out in Table 2 for the surface roughness of the metal sintered object manufactured using the additive manufacturing powder of each sample number with reference to the surface roughness of the metal sintered object manufactured using the additive manufacturing powder of Sample No. 7. Similarly, relative evaluation was carried out in Table 3 with reference to the surface roughness of the metal sintered object manufactured using the additive manufacturing powder of Sample No. 14, and relative evaluation was carried out in Table 4 with reference to the surface roughness of the metal sintered object manufactured using the additive manufacturing powder of Sample No. 18. The evaluation results are shown in Table 2 to Table 4.
A: The relative value of surface roughness is less than 80% of the reference value.
B: The relative value of surface roughness is 80% or greater and less than 90% of the reference value.
C: The relative value of surface roughness is 90% or greater and less than 100% of the reference value.
D: The relative value of surface roughness is 100% or greater of the reference value.

[symbol]

TABLE 2

| | | Configuration of additive manufacturing powder | | | | | | | | | |
|---|---|---|---|---|---|---|---|---|---|---|---|
| | | | Representative particle size | | | | | | | Specific | |
| | | Steel | | | | | D90- | D10/ | D90/ | surface | |
| Sample | Classi- | type | D1 [symbol] | D50 | D90 | [symbol] | [symbol] | D50 | D50 | area | [symbol] |
| No. | fication | — | μm | μm | μm | μm | μm | — | — | m²/g | — |
| 1 | Example | 1 | 3.4 | 7.1 | 14.3 | 20.9 | 10.9 | 0.48 | 2.01 | 0.175 | 0.92 |
| 2 | Example | 1 | 3.4 | 7.0 | [symbol] | 33.7 | 14.0 | 0.49 | [symbol] | 0.195 | 0.87 |
| 3 | Example | 1 | 2.9 | 8.8 | 15.4 | 24.1 | 12.5 | 0.43 | [symbol] | 0.236 | 0.87 |
| 4 | Example | 1 | 3.7 | [symbol] | 14.5 | 22.0 | [symbol] | 0.49 | [symbol] | 0.155 | 0.94 |
| 5 | Example | 1 | [symbol] | [symbol] | 15.5 | 24.3 | [symbol] | 0.42 | 2.25 | 0.220 | 0.86 |
| 6 | Compar- | 1 | 2.9 | 7.0 | 18.7 | 33.4 | 15.8 | 0.41 | [symbol] | 0.241 | 0.84 |
| | ative | | | | | | | | | | |
| | example | | | | | | | | | | |
| 7 | Compar- | 1 | 2.9 | [symbol] | 19.0 | [symbol] | 16.1 | 0.41 | [symbol] | 0.257 | [symbol] |
| | ative | | | | | | | | | | |
| | example | | | | | | | | | | |
| 8 | Compar- | 1 | 2.9 | 7.0 | 18.8 | 33.9 | [symbol] | 0.41 | [symbol] | 0.250 | 0.80 |
| | ative | | | | | | | | | | |
| | example | | | | | | | | | | |
| 9 | Compar- | 1 | [symbol] | 7.2 | 18.3 | [symbol] | 16.5 | 0.39 | [symbol] | 0.249 | [symbol] |
| | ative | | | | | | | | | | |
| | example | | | | | | | | | | |
| 10 | Compar- | 1 | 2.9 | 7.3 | 19.6 | 34.7 | 16.7 | 0.40 | [symbol] | 0.245 | 0.83 |
| | ative | | | | | | | | | | |
| | example | | | | | | | | | | |

| | | | Evaluation result | | | | |
|---|---|---|---|---|---|---|---|
| | | | | | Ratio of | | |
| | Configuration of additive | | | | tapped | | |
| | manufacturing powder | | | | density | | |
| | Oxygen | Water | Bulk | Tapped | to bulk | Relative | Surface |
| Sample | [symbol] | [symbol] | density | density | density | density | roughness |
| No. | ppm | ppm | g/cm [symbol] | g/cm [symbol] | — | — | — |
| 1 | 2443 | 90 | 3.12 | [symbol] | 1.50 | A | A |
| 2 | 2582 | 93 | [symbol] | [symbol] | [symbol] | A | A |
| 3 | [symbol] | [symbol] | 3.00 | 4.52 | [symbol] | B | A |
| 4 | [symbol] | 75 | 3.16 | 4.52 | [symbol] | A | A |
| 5 | 3750 | 128 | 3.04 | 4.72 | 1.55 | B | A |
| 6 | 3359 | 141 | 2.47 | 4.26 | [symbol] | [symbol] | C |
| 7 | [symbol] | [symbol] | 2.31 | 4.18 | 1.81 | [symbol] | — |
| 8 | 3623 | [symbol] | 2.34 | 4.20 | 1.79 | D | D |
| 9 | [symbol] | 155 | [symbol] | 4.22 | 1.77 | D | C |
| 10 | 3420 | 151 | 2.44 | 4.24 | 1.74 | D | C |

[symbol]

indicates data missing or illegible when filed

TABLE 3

| | | Configuration of additive manufacturing powder | | | | | | | | | | | | | |
|---|---|---|---|---|---|---|---|---|---|---|---|---|---|---|---|
| | | | Representative particle size | | | | | | | Specific | | | | Evaluation result | |
| | | Steel | | | | | D90- | D10/ | D90/ | surface | [symbol] | Oxygen | Water | Relative | Surface |
| Sample | Classi- | type | [symbol] | D50 | [symbol] | D99 | [symbol] | D50 | D50 | area | [symbol] | [symbol] | [symbol] | density | roughness |
| No. | fication | — | μm | μm | μm | μm | μm | — | — | m²/g | — | ppm | ppm | — | — |
| 11 | Example | 2 | 4.7 | 8.3 | [symbol] | 19.1 | 11.3 | [symbol] | [symbol] | 0.240 | 0.87 | 3110 | 95 | B | B |
| 12 | Example | 2 | 5.0 | [symbol] | 17.0 | 31.9 | [symbol] | [symbol] | [symbol] | 0.231 | [symbol] | [symbol] | 83 | A | A |
| 13 | Example | 2 | 4.3 | 7.2 | 14.7 | 22.3 | 10.4 | [symbol] | 2.04 | 0.245 | 0.86 | 3240 | 100 | B | A |
| 14 | Comparative | 2 | 2.5 | 9.0 | 21.0 | 36.0 | [symbol] | [symbol] | 2.33 | [symbol] | 0.72 | 3369 | 320 | D | — |
| | example | | | | | | | | | | | | | | |
| 15 | Comparative | 2 | 2.1 | 6.5 | 13.0 | 16.0 | [symbol] | 0.32 | 2.00 | 0.253 | 0.85 | 3746 | [symbol] | D | A |
| | example | | | | | | | | | | | | | | |

[symbol]

indicates data missing or illegible when filed

TABLE 4

| | | Configuration of additive manufacturing powder | | | | | | | | | | | | | |
|---|---|---|---|---|---|---|---|---|---|---|---|---|---|---|---|
| | | | Representative particle size | | | | | | | Specific | | | | Evaluation result | |
| | | Steel | | | | | D90- | D10/ | D90/ | surface | [symbol] | Oxygen | Water | Relative | Surface |
| Sample | Classi- | type | D10 | D50 | D90 | D99 | D10 | D50 | D50 | area | [symbol] | [symbol] | content | density | roughness |
| No. | fication | — | μm | μm | μm | μm | μm | — | — | m²/g | — | ppm | ppm | — | — |
| 16 | Example | 3 | 2.4 | 4.2 | 7.5 | 17.3 | [symbol] | 0.57 | 1.79 | 0.248 | 0.95 | 3850 | 185 | B | B |
| 17 | Example | 3 | 7.2 | 12.0 | 18.5 | 22.0 | 11.3 | [symbol] | [symbol] | 0.176 | 0.89 | 1230 | 50 | B | C |
| 18 | Comparative | 3 | 2.2 | 5.3 | 17.0 | 36.0 | 14.8 | 0.42 | 3.21 | 0.350 | 0.78 | 4530 | 280 | D | — |
| | example | | | | | | | | | | | | | | |

[symbol]

indicates data missing or illegible when filed

### 7.4. Examination of Evaluation Results

As shown in Table 2, the additive manufacturing powder of each example had both high bulk density and high tapped density. The high bulk density and high tapped density are considered to contribute to the flowability and filling property of the additive manufacturing powder. As such, when the additive manufacturing powder was used to produce an additively manufactured object, which was in turn sintered to produce a metal sintered object, the resulting metal sintered object had high relative density and good surface roughness. In addition, as shown in Table 3 and Table 4, metal sintered objects having high relative density and good surface roughness were also produced using the additive manufacturing powders of other examples.

From the above, it was found that the additive manufacturing powder of the present disclosure has both good sinterability and good flowability and, as a result, can yield a metal sintered object having high density and high surface accuracy.

What is claimed is:

1. An additive manufacturing powder comprising an Fe-based metal material and used to manufacture an additively manufactured object, the additively manufactured object being to be turned into a metal sintered object by sintering, wherein the additive manufacturing powder has a particle size D50 of 1.0 μm or greater and less than 15.0 μm, and a particle size difference D90-D10 between a particle size D90 and a particle size D10 of from 5.0 μm to 18.0 μm, where, in a volume-based cumulative particle size distribution curve measured by laser diffraction, D10 is a particle size at which a cumulative volume of particles reaches 10% as counted from a smaller side, D50 is a particle size at which the cumulative volume of the particles reaches 50% as counted from the smaller side, and D90 is a particle size at which the cumulative volume of the particles reaches 90% as counted from the smaller side,
the additive manufacturing powder has a specific surface area of from 0.05 [m²/g] to 0.25 [m²/g],
the additive manufacturing powder has a water content of 200 ppm or less as measured by a Karl Fischer method at 250° C., and an average circularity of the particles is from 0.85 to 0.99.

2. The additive manufacturing powder according to claim 1, wherein
an oxygen content is from 1000 ppm to 4000 ppm.

3. The additive manufacturing powder according to claim 1, wherein
the particle diameter D50 is from 4.0 μm to 10.0 μm.

4. The additive manufacturing powder according to claim 1, wherein
the specific surface area is from 0.10 [m²/g] to 0.22 [m²/g].

5. The additive manufacturing powder according to claim 1, wherein
the water content is from 30 ppm to 150 ppm.

6. The additive manufacturing powder according to claim 1, wherein
the Fe-based metal material is stainless steel.

7. The additive manufacturing powder according to claim 1, wherein
a ratio of a tapped density to a bulk density is from 1.2 to 1.8.

8. An additively manufactured object comprising:
the additive manufacturing powder according to claim 1; and
a binder configured to bond together the particles of the additive manufacturing powder.
